(19) United States
(12) Patent Application Publication
(10) Pub. No.: US 2005/0096936 A1
(43) Pub. Date: May 5, 2005

(54) System for distributing and vending data

(76) Inventor: Thomas Lambers, Prospect, OH (US)

Correspondence Address: ELEY LAW FIRM CO., P.O. BOX 340557, COLUMBUS, OH, 43234-0557, US

(21) Appl. No.: 10/976,656

(22) Filed: Oct. 29, 2004

Related U.S. Application Data
(60) Provisional application No. 60/516,090, filed on Oct. 30, 2003.

(51) Int. Cl. G06F 17/60

(52) U.S. Cl. 705/1; 705/43

(57) ABSTRACT

A system for distributing and vending data. The system includes a processing center adapted to collect data and a plurality of vending machines adapted to receive data from the processing center. Copies of the data collected by the processing center are distributed to the vending machines and vended by the machines. In some embodiments the data may be collected by the processing center and distributed to the vending machines by a telecommunications link. The data may be secured to prevent interception and unauthorized use of the data. A method employs the system.

This application claims the benefit of provisional patent application No. 60/516,090, filed Oct. 30, 2003, incorporated herein by reference.

### FIELD

The present invention relates to a system for distributing and vending data, and more particularly, a system for automated point-of-sale vending of data.

### BACKGROUND

Advances in technology have provided consumers with a variety of productivity and entertainment devices, such as computers, audio players, hand-held, console and computer games, and digital video disk (“DVD”) players. All of these devices require ancillary components for operation. For example, computers and games require software programs, audio players require at least one of compact disks (“CDs”), cassette tapes, magnetic tapes and MP3 files, and DVD players require DVDs containing video and audio. Video, audio, computer software and game software may also be stored on other types of media, such as magnetic disks, optical disks and electronic memory devices. For purposes of this disclosure these various ancillary components are generally termed “data.”

Data can be obtained at a variety of retail outlets. CDs, for example, are widely available at music and department stores. Similarly, DVDs may be purchased or rented from video stores. However, physical limitations force retail CD, software and DVD outlets to limit their inventories, which means that consumers are able to choose from only a small portion of the body of published data.

Several alternatives to retail outlets are available. For instance, data can be purchased by downloading it via the internet. However, this requires a computer system having a high-speed internet connection and the capability to record the data onto blank media, such as a CD or DVD disk, for use with the desired entertainment device. In addition, even with high speed internet access it can take as much as two hours to download one film. High-speed internet connections and recording equipment, although becoming more popular, are still not widely available to many consumers. Even if available, the cost of the computer, recording equipment and high-speed internet access may still be prohibitive to some consumers. Aside from the cost factor, many consumers are not sufficiently proficient with the internet, e-commerce and recording on media to obtain data online. Still other customers are unwilling to take the time necessary to obtain data via the internet and record it onto a disk for later playback.

Another outlet for data purchases is mail order. However, this option is not attractive due to the amount of time required to receive the data after an order is placed. Many consumers are also unwilling to expend the time and effort required to assemble and place an order by mail. In fact, a significant portion of data purchases are “impulse” buys, typically made as a result of a response to an attractive display for the data at a retail outlet.

There is a need for a process whereby consumers are able to purchase data at a reasonable cost. There is a further need for a source of data having a wide selection without a need for a correspondingly large physical space to house the data. There is a still further need for a way for consumers to purchase data that does not require expensive computers and recording equipment or computer skills. Lastly, there is a need for a way to provide consumers with their desired data selections upon demand and without undue delay.

### SUMMARY

The present invention overcomes the problems of limited inventory, space constraints, and the cost and delivery time presently associated with the sale of data. Data is created at various sources, such as music and movie studios, and by software and gaming companies. Copies of the data from the various sources are collected at a processing center where it is organized into a master library. At least a portion of the data is then distributed to regional distribution points. The regional distribution points further distribute the data to districts, who in turn distribute the data to automated data vending machines for self-service sale to consumers.

In another embodiment, data files are transferred securely from the processing center directly to the automated vending machines. Data transfer may be accomplished using satellite telecommunications and/or the internet. In this embodiment distribution to regions or districts may be limited or eliminated altogether.

The automated data vending machines are adapted to enable self-service by consumers. The vending machines contain a wide variety of data selections stored in an electronic form, such as within a computer data storage device. The vending machine further includes a self-contained video display and audio system, and controls that permit customers to browse through an electronic catalog. Excerpts of the data selections may also be previewed by a customer. Once a selection is made, the customer makes payment by any convenient means, such as an automated bill changer and credit or debit card reader. Once payment has been made, the vending machine retrieves a copy of the selected data, such as a CD or DVD, from an internal inventory and vends the data to the customer.

An aspect of the present invention is a system for distributing and vending data. The system comprises a processing center adapted to collect data and a vending machine adapted to receive and store data from the processing center. Copies of the data collected by the processing center are distributed to the vending machine for vending by the machine.

Another aspect of the present invention is a system for distributing and vending data. The system comprises a processing center adapted to collect data, a plurality of regions adapted to receive data from the processing center, a plurality of districts, wherein the districts are logically associated with the regions and adapted to receive data from the regions, and a plurality of vending machines, wherein the vending machines are logically associated with the districts and adapted to receive data from the districts. Copies of the data collected by the processing center are distributed to the vending machines and vended by the machines.

Yet another aspect of the present invention is a machine for vending data in a system for distributing and vending data. The machine comprises a data input/output subsystem, a user input subsystem for selecting data, and a transaction subsystem. The machine vends selected data in accordance with inputs to the machine via the user input subsystem and the transaction subsystem.

Still another aspect of the present invention is a method for vending data. The method comprises the steps of initiating a transaction, displaying a menu, selecting data from the menu, making payment for the selected data, and vending a medium containing a copy of the selected data.

Another aspect of the present invention is a method for controlling the inventory of a machine for vending data. The method comprises the steps of building an initial inventory comprising copies of the data, monitoring sales of the inventory, and generating additional copies of the data when the inventory reaches a predetermined level.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a block diagram showing the general arrangement of an organization for distributing data according to an embodiment of the present invention;

FIG. 2 is a block diagram showing the general arrangement of an organization for distributing data according to another embodiment of the present invention.

FIG. 3 is a block diagram of an automated data vending machine according to an embodiment of the present invention;

FIG. 4 is a flow diagram illustrating a method for vending data according to an embodiment of the present invention; and

FIG. 5 is a flow diagram depicting a method for tracking and controlling inventory according to an embodiment of the present invention.

### DETAILED DESCRIPTION

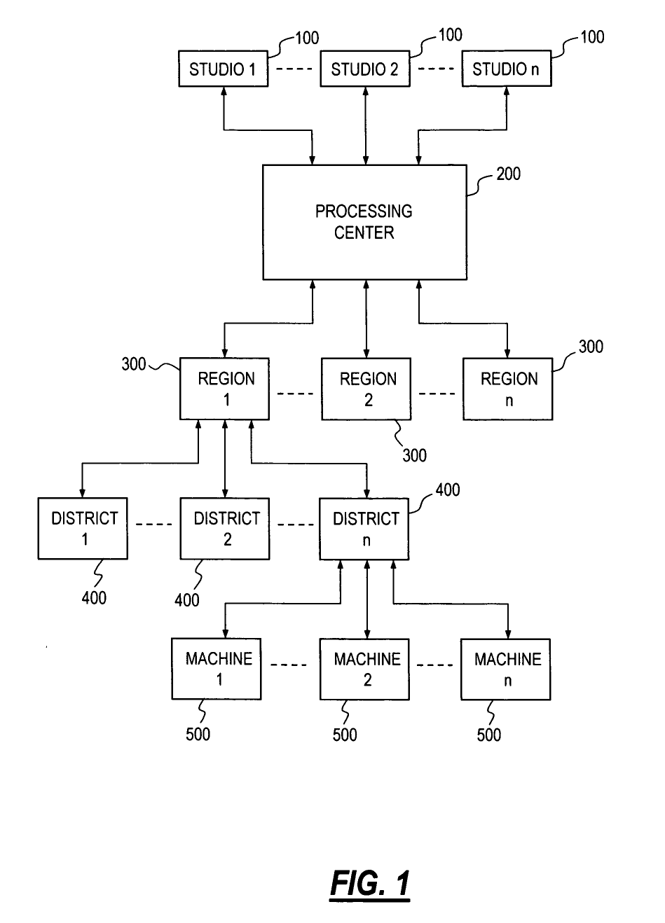

A block diagram of the general arrangement of an organization for distributing and vending data according to an embodiment of the present invention is illustrated in FIG. 1. Various forms of data including, but not limited to, audio, music, movies and computer software are created and published by audio recording studios, movie studios, software development companies, gaming companies and the like, termed collectively herein as “studios” 100. Data may also include such ancillary items as menus, trailers, media setting and calibration information, demos, promotional clips, and sound bites. The data is transferred from studios 100 to a processing center 200. The data may be transferred by any conventional telecommunications link, such as via electronic file transfer, terrestrial and satellite-based high-speed data links, telephone connections, cellular networks and electronic computer networks. Data transfer may also be effected by physically transporting recorded electronic media by courier, postal service and express package delivery. The data is collected and organized by processing center 200 to create a master library. The aforesaid telecommunications and physical transport means may also be used to send business information such as financial data, sales figures, administrative information and royalty payments from processing center 200 to the studios 100.

At least a portion of the data residing in the master library is subsequently transferred from processing center 200 to a plurality of regions 300. The data may be transferred by any conventional telecommunications or physical transport means, as previously described. The data may be transferred on a regular schedule, or may be based on a current or anticipated demand for the data. The electronic and/or physical data transfer means may also be used to send business information, such as sales figures and vending metrics, from each region 300 to processing center 200.

The data is further distributed from regions 300 to a plurality of districts 400 within each region. The data may be transferred by any conventional electronic or physical means, as previously described. The data may be transferred on a regular schedule, or may be based on a current or anticipated demand for the data. The electronic and/or physical data transfer means may also be used to send business information, such as sales figures and metrics, from each district 400 to their respective region 300.

Finally, the data is distributed from districts 400 to a plurality of automated data vending machines 500 located within each district. The data may be transferred by any conventional electronic or physical means, as previously described. Further, the data may be transferred on a regular schedule, or may be based on a current or anticipated demand for the data. The electronic communications and/or physical transfer means may also be used to send business information, such as sales figures and metrics, from each machine 500 to their respective district 400. Districts 400 may also provide maintenance to the vending machines 500, replenish stock, collect money from the vending machines, install vending machines, and replace machines as needed.

The regions 300, districts 400 and machines 500 may be organized and located in any conventional manner, such as geographically, in accordance with a population distribution, or in association with particular venues. Example venues include, but are not limited to, fast food restaurants such as pizza parlors, grocery stores, and convenience stores. Vending of data may also be made part of a delivery service, such as pizza delivery, providing customers with food and entertainment from a single, convenient source.

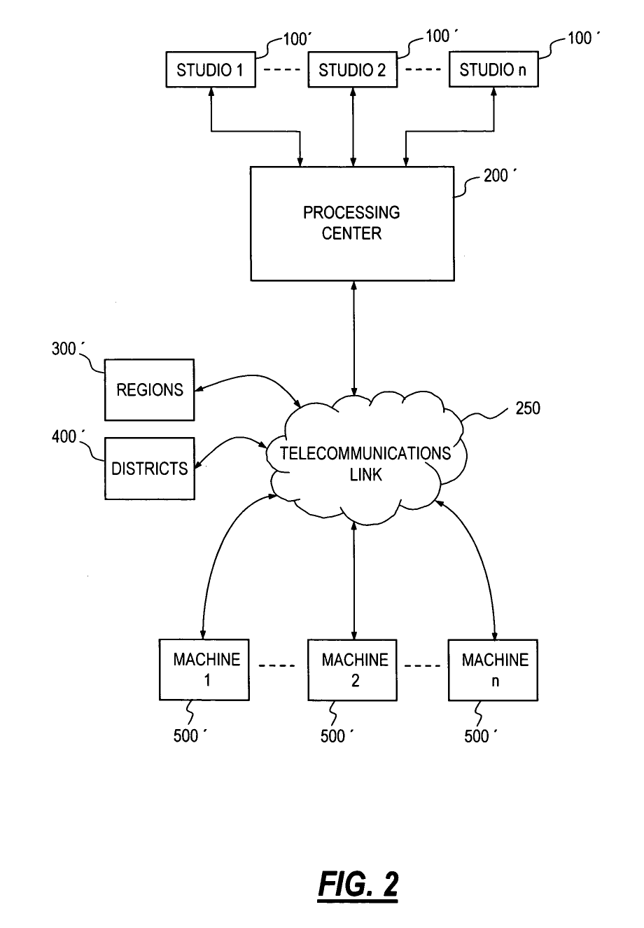

An alternate embodiment of the present invention is depicted in the block diagram of FIG. 2. Studios 100′, processing center 200′ and machines 500′ are structured in the manner previously described for studios 100, 200 and 500 respectively, and function identically. Processing center 200′ is directly linked to machines 500′ by telecommunication means 250. Telecommunication means 250 may include, without limitation, wired or wireless internet, telephone, and terrestrial and satellite-based high-speed data networks, electronic computer networks and data buses. Data may flow unidirectionally from processing center 200′ to machines 500′, such data including, without limitation, films and film data, control signals and status signals. In other embodiments communications between processing center 200′ and machines 500′ may be bidirectional, allowing the machines to transmit to the processing center such data as operational status, customer orders, machine or system fault data, inventory levels, security breaches, statistical data such as most/least popular customer selections and peak usage times/dates, and transaction data such as credit card and debit card account information.

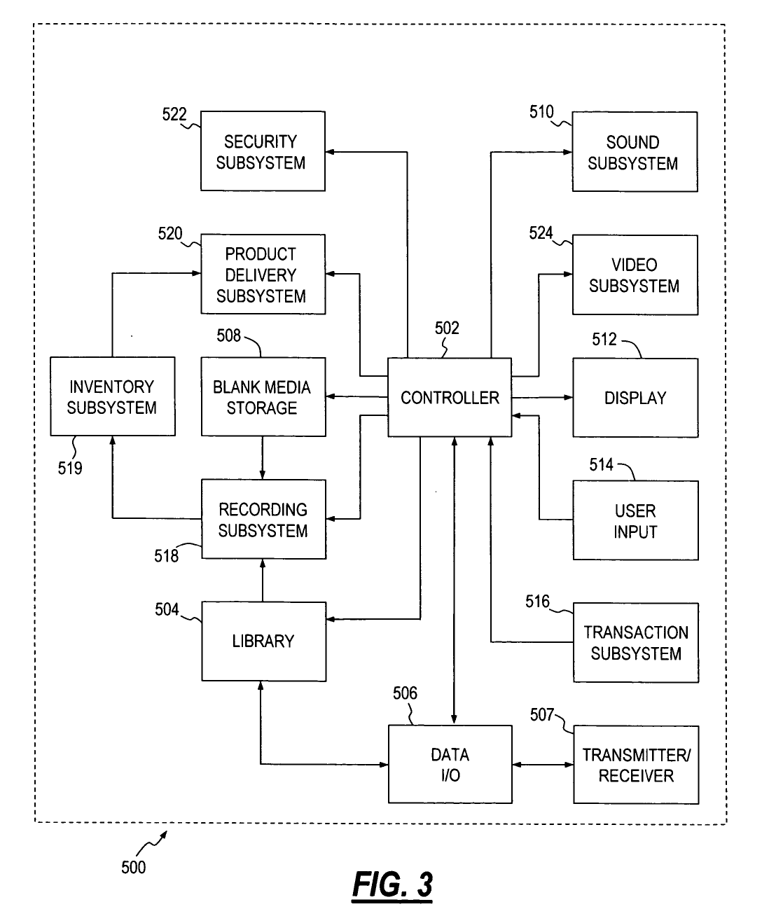

A block diagram of the general arrangement of an automated data vending machine 500 is shown in FIG. 3. A controller 502, such as a conventional computer, microprocessor, programmable logic control or programmable logic device acts as a central processing unit, and controls the electrical and mechanical operation of vending machine 500 by appropriate interaction with a plurality of subsystems, described below. Controller 502 may further include a set of predetermined instructions, such as a computer program (not shown).

Vending machine 500 includes a library 504 adapted to store data in the vending machine. The library may include any conventional electronic means for storing data, such as a magnetic or optical computer hard drive, static memory, dynamic memory, random access memory, and read only memory.

Data may be transferred to library 504 by means of a data input/output (“I/O”) subsystem 506. I/O subsystem 506 may include, without limitation, buffers, level shifters, logic inverters, transient suppressors and data bus controllers. Data received by I/O subsystem 506, such as status and control signals, may also be provided to controller 502.

Data may be presented to I/O subsystem 506 by an electrical “umbilical” cable connection to an external data storage and transfer device, such as a portable computer (not shown). Alternatively, data transfer may be effected by telecommunications link connected to a source for data. In such embodiments vending machine 500 further includes a transmitter/receiver 507. Transmitter/receiver 507 may be any conventional wired or wireless data transmitter/receiver, and may be adapted to interface with telephone-based networks, private and public computer networks, cable-based networks, satellite-based networks, data buses, the internet and the like. Data transfer may be unidirectional such that vending machine 500 only receives data, or may be bidirectional such that the vending machine both transmits and receives data. In bidirectional embodiments vending machine 500 can receive data such as films, operating commands, status signals and the like, and transmit to a processing center 200′ (see FIG. 2) such data as operational status, customer orders, fault data, inventory levels, security breaches, and statistical data such as sales figures, most/least popular customer selections and peak usage times/dates.

A storage subsystem 508 holds a plurality of blank recordable media including, but not limited to, CD-R, CD-R/W and DVD. Storage subsystem 508 is adapted to receive blank media during maintenance by district 400 personnel, hold the media in storage, and supply it to a recording subsystem 518 when a blank media is needed for recording. Storage system 508 may optionally include devices for determining the amount of media available, such as a counter or scale, and provide an aural or visual alert signal to an attendant (such as a clerk at the store where the machine 500 is located) if the stock of blank media is low. Storage system 508 may optionally send an alert to any or all of district 400′ personnel, regional personnel 300′ and processing center 200′ via a wired or wireless means, such as telecommunications link 250 (see FIGS. 1-3).

A sound sub-system 510 and display 512 allow a customer to browse through the selections available in library 504, and provides the customer with information related to the selections, such as audio and video excerpts of the selections. The sound subsystem may have a plurality of volume levels commensurate with the operating mode of vending machine 500. For example, the volume may be set to a relatively high level in order to attract attention when no customers are near vending machine 500, then automatically adjust to a lower level when the vending machine is being used by a customer. For example, customer activity at a user input subsystem 514 can be used as an indicator to controller 502 to reduce the volume of sound subsystem 510. Similarly, conventional motion sensors, infrared heat sensors, ultrasonic proximity sensors and infrared “trip wire” transmitter/receivers can also be used to detect customers in proximity to vending machine 500 and accordingly signal controller 502 to reduce the volume of sound subsystem 510.

User input subsystem 514 allows the customer to browse the library via display 512 and sound subsystem 510, and make selections. Customer input subsystem 514 may be any combination of conventional input devices such as, for example, a keyboard, pointing device, touch-screen, trackball, switches, keys, controls and a “mouse” pointer.

A transaction subsystem 516 handles payment in any conventional manner. For example, the transaction sub-system 516 may be a currency-accepting device, such as a bill changer. Transaction subsystem 516 may further include a credit card and/or debit card reader. Transaction subsystem is preferably adapted to store currency and transaction data in a secure repository in order to discourage theft. Transaction subsystem 516 may optionally include a printing device for printing receipts for transactions, news, special incentives, coupons, and the like, and may additionally be configured to print only when requested by a customer via user input 514 or when commanded by controller 502 in accordance with predetermined instructions.

A recording subsystem 518 obtains blank media from storage subsystem 508 and records selected data from library 504 onto the blank media. Recording subsystem 518 may comprise any conventional recording device, such as single and gang compact disk and digital video disk recorders. Other operations performed by recording subsystem 518 may include identification of the recorded media by any conventional means including, without limitation, labels, laser, inkjet, bubble jet, etching and printing.

Finished product, comprising CD or DVD disks with recorded data, are then placed in an inventory subsystem 519 to await sale. Inventory subsystem 519 may be arranged in any manner suitable for automated retrieval, such as horizontal and vertical stacks and racks, pick-and-place devices, magazines, trays and disk autoloaders.

Product delivery subsystem 520 retrieves finished product from inventory subsystem 519 and provides it to a customer as part of an automated transaction whereby the customer selects a product as previously described and pays for it via transaction subsystem 516. Product delivery subsystem 520 may be any conventional mechanical, pneumatic or electro-mechanical device adapted to retrieve product from inventory subsystem 519 and vend it to the customer. Product delivery subsystem 520 may include any desired combination, of opening, chute, and door. Product delivery subsystem is preferably adapted to isolate inventory 519 from customer access, thereby deterring theft of finished product.

Vending machine 500 may also include a security subsystem 522 to deter vandalism and prevent theft of components, blank media, finished data product, currency and credit/debit card transaction data. Security subsystem 522 may comprise a motion sensor (not shown) to detect the presence of a customer. The motion sensor may be used to activate a video subsystem 524, such as a security camera, to record video of any activity taking place proximate vending machine 500. The security camera may be any conventional camera, such as a digital or magnetic-tape recorder. The motion sensor may also work in concert with sound subsystem 510 to control the volume level from a higher level to a lower level when a customer approaches the vending machine. Security system 522 may further comprise a tilt sensor and an alarm to detect and deter vandalism. The alarm may be any combination of silent, visual and aural, and an alarm signal may optionally be routed to any of law enforcement, private security and district 400 company personnel via telecommunications link 250.

In yet another embodiment, vending machines 500 may include a Global Positioning Satellite (“GPS”) receiver. In such embodiments vending machine 500 may include a conventional internal GPS antenna, if the vending machine is positioned such that the antenna has a sufficiently clear “view” the GPS satellites. Alternatively, vending machines 500 may be connected to a remotely-located GPS antenna. If power to vending machine 500 is removed and then restored, the vending machine may reestablish telecommunications with processing center 200′ (see FIG. 2), reestablish the GPS signal, and then become operational. In the event a vending machine 500′ is stolen, moved to another location and then re-energized, if the vending machine cannot reestablish telecommunications with processing center 200′, and/or there is no GPS signal and/or the GPS signal received by the vending machine indicates that the vending machine is outside a predetermined range of longitudes and latitudes (i.e., locations within a predetermined locale, such as a store), the vending machine maybe configured to automatically delete all internally stored data files to prevent unauthorized use and copying of the data files. In such embodiments a tilt sensor may optionally be deleted, or may be used for redundant security.

In the event that vending machine 500′ is moved outside its assigned range of longitudes and latitudes and is subsequently able to establish telecommunications with processing center 200′ and further is able to receive GPS signals, the vending machine may be configured to transmit to the processing center its location (i.e., longitude and latitude from GPS data) and status information, such as the extent of security breaches. This information may be utilized by processing center 200′, in cooperation with applicable authorities and other security personnel, to locate and recover vending machine 500′ and apprehend thieves.

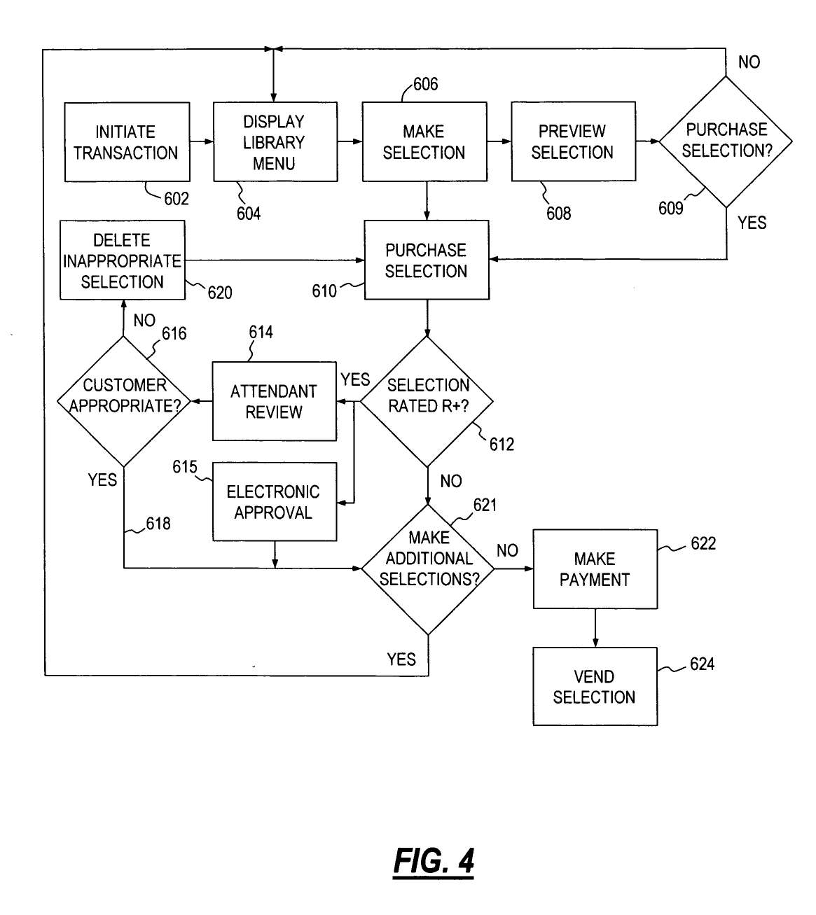

Referring to FIG. 4 in combination with FIG. 3, a method of vending data is depicted. A customer initiates a transaction at step 602 by approaching a vending machine 500. A listing of data available from library 504 of vending machine 500 is communicated to the customer at step 604. The listing is provided by display 512, and may be accompanied by audio from sound subsystem 510. The customer reviews the available data and makes an initial selection at step 606. At this point the customer has a choice of previewing the selection or obtaining additional details about the selection (i.e., movie “trailers,” excerpts from music, advertisements, etc.), as at 608, or bypassing the preview and purchasing the selection, as at 610. At step 609 the customer decides whether to purchase the selection or to make a new selection. If the customer decides to make a new selection, the method moves back to step 604 so that the customer can browse for other data of interest. If the customer decides to purchase the current selection, the method moves to step 610. If at 612 the selection meets predetermined criteria, such as an industry rating for mature content, an attendant may be signaled at 614 to review the transaction for appropriateness in accordance with predetermined criteria, such as the age of the customer and an industry rating of the data, before the vending process is continued. The indication to the attendant may be any form of attention-getting signal, such as a flashing light and/or an audio annunciation. The attendant makes a decision regarding the customer at 616. If the customer is of sufficient age, the attendant signals the vending machine 500 to continue, as at 618. The signal from the attendant may be provided to data vending machine 500 by any conventional means, such as a wired or wireless remotely-mounted switch located at an attendant station. Alternatively, a key-actuated switch may be affixed to the vending machine 500. If the customer is not of sufficient age for the selected data, the attendant deletes the inappropriate selection from the pending list of selections for purchase at 620 and resets the process to 610. The customer may then make a more appropriate selection.

In one embodiment of the present invention, if at 612 a selection having an R-rating (or other industry rating indicating mature-theme data) is detected, an automatic screening for appropriateness may be performed at 615 based on customer authorization data, eliminating the need for an attendant to check and approve the transaction. Authorization data may include, without limitation, name, address and age data furnished by the customer in association with debit cards, credit cards, membership cards issued by vendors using systems 500 or 500′, membership cards issued by others, personal identification numbers (“PIN”), passwords, RFID tags, signature recognition systems, biometric recognition systems and state-issued identity cards such as drivers' licenses. Accordingly, data I/O subsystem 506 may be adapted to receive data from any or all of the foregoing. It should be noted that a predetermined requirement for issuance of authorization data may itself serve as a sufficient indication of authorization. An example is a membership card in an organization that requires compliance with the predetermined criteria (such as a minimum age) for eligibility. The authorization data may be provided by using Data I/O subsystem 506 (see FIG. 3), which may also be adapted to accept credit and/or debit cards for payment by electronic transactions. A password and/or a predetermined personal identification number may optionally be required for all electronic transactions, regardless of the industry rating of the selections, providing even greater protection for the consumer by preventing, for example, unauthorized access to the customer's account or unauthorized credit/debit card transactions.

At step 621 the customer decides whether to select additional choices or complete the transaction. If the customer decides to continue browsing, the method stores the current selections in a memory portion (not shown) of controller 502 and then moves to step 604 to again display the list of available choices. When the customer is ready to complete the transaction, the method moves to step 622.

Payment for the customer's selection is made at step 622. Display 512 and user input 514 may be used to review the current selections, make any changes, and enter any information needed. Payment may be made with currency, or with credit and debit cards using transaction subsystem 516 as previously described. The selection is then vended to the customer at step 624 by means of product delivery sub-system 520, which retrieves the selected product from inventory subsystem 519.

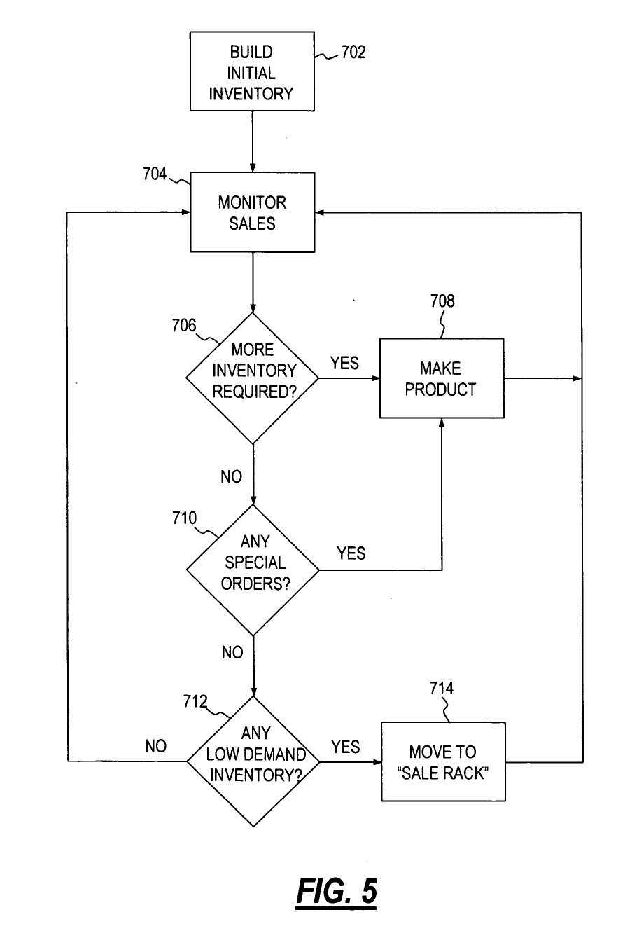

Referring now to FIG. 5 in combination with FIG. 3, a flow diagram of a method for controlling the inventory housed in a vending machine 500 of FIG. 2 is shown according to an embodiment of the present invention. At step 702 an initial inventory of selections are generated and placed into the inventory subsystem. The initial inventory may be produced by vending machine 500, wherein recording subsystem 518 obtains blank media from storage subsystem 508 records product using the data in library 504, and places the finished product in inventory subsystem 519. Alternatively, the inventory may be generated remotely wherein finished product is loaded directly into inventory 519 by an attendant. At step 704 sales of the inventory are regularly monitored to track a number of metrics, such as a running history of number of units sold, the number of units remaining in stock, the rate of sales, and peak demand days and times. These metrics are used to automatically (by means of a computer program) or manually generate an algorithm to anticipate the future demand for each selection in the inventory, as at step 706. If the anticipated demand for a selection exceeds the current inventory, recording subsystem 518 is commanded to replenish the inventory for the selection at step 708. Inventory is preferably replenished during periods of low vending activity for machine 500, as determined from the tracked metrics and the algorithm. Replenishment may be accomplished internally by vending machine 500

In another embodiment the inventory of vending machine 500′ (see FIG. 2) may be remotely monitored, manually or automatically, by processing center 200′. Vending machine 500′ may then be remotely commanded via telecommunications link 250 to replenish the inventory using data in library 504 (see FIG. 3) and blank media 508. Additional data may also be transmitted to vending machine 500 via telecommunications link 250, the additional data being stored in library 504 for use by recording subsystem 518. Alternatively, an attendant may be dispatched to replenish the inventory.

If the inventory is adequate, a check is made for any special orders at 710. Special orders may include customer requests for low-demand or special-interest selections. A customer may place requests in any conventional manner, such as by calling a predetermined ordering number and arranging for the request to be fulfilled at a vending machine 500 of the customer's choosing. Alternate methods of placing special orders include via internet web pages, e-mail, and entry of the request to a memory portion (not shown) of a vending machine 500. The special-order data may be placed into library 504 of vending machine 500 by district personnel 400 (see FIG. 1) or by direct telecommunication means from processing center 200′ (see FIG. 2), and may be fulfilled by generating a finished product at step 708 by means of recording subsystem 518. Vending machine 500 may optionally produce several copies of the special order and make them available to other customers by promoting the special-order selection on display 512.

At step 712 the sales metrics are periodically checked to see if any low-demand or otherwise excess inventory exists. If so, this inventory may be added to a “sale rack” at step 714 wherein the low-demand inventory is promoted on display 512 with purchase incentives, such as price discounts, frequent-purchaser credits, and volume-purchase incentives such as “two-for-one” specials.

As previously noted, electronic transfer of data to and from vending machines 500′ by telecommunication means is preferably secured in order to prevent interception and/or unauthorized use of the data. Any conventional form of security may be used including, without limitation, virtual private networks (“VPN,”) encryption and decryption of data, authentication and authorization of access to data, and digital signature and certification authorities (“CA”). Such techniques are well-known in the art of data security and will be left to the artisan.

It should be noted that data to be vended may be in any format and/or any medium now known, for use with any compatible system or equipment. In addition, the present invention may be easily adapted by one skilled in the art to vend data in formats and/or media not yet developed, by appropriate modification of the machines 500 to store, record and vend such data. Examples of data include, but are not limited to, audio, video, electronic games and computer programs stored on various media such as magnetic disks, optical disks, compact disks, electronic memory devices (e.g., ROM, RAM, PROM, EPROM, EPLD and so on), cassettes, magnetic tape, MP3, and digital video disks (“DVD”). Other data formats and media will occur to the artisan, and are within the scope of the invention.

Having illustrated and described the principles of the present invention with reference to several preferred embodiments, it should be apparent to those of ordinary skill in the art that the invention may be modified in arrangement and detail without departing from such principles.

1. A system for distributing and vending data, comprising:
a processing center adapted to collect data; and
a vending machine adapted to receive and store data from the processing center,
wherein copies of the data collected by the processing center are distributed to the vending machine for vending by the machine.

2. The system of claim 1 wherein the data comprises at least one of audio, video, an electronic game and a computer program stored on at least one of a magnetic disk, optical disk, compact disk, electronic memory device, cassette, magnetic tape, MP3, and digital video disk media.

3. The system of claim 2 wherein the vended data is stored on the media prior to vending.

4. The system of claim 1, further including a telecommunications link to distribute the data to the vending machine.

5. The system of claim 4 wherein the data is made secure before being distributed to the vending machine.

6. The system of claim 1 wherein the data is communicated to the processing center by a telecommunications link.

7. The system of claim 6 wherein the data is made secure before being communicated to the processing center.

8. A system for distributing and vending data, comprising:
a processing center adapted to collect data;
a plurality of regions adapted to receive data from the processing center;
a plurality of districts, wherein the districts are logically associated with the regions and adapted to receive data from the regions; and
a plurality of vending machines, wherein the vending machines are logically associated with the districts and adapted to receive data from the districts,
wherein copies of the data collected by the processing center are distributed to the vending machines and vended by the machines.

9. The system of claim 8 wherein the data comprises at least one of audio, video, an electronic game and a computer program stored on at least one of a magnetic disk, optical disk, compact disk, electronic memory device, cassette, magnetic tape, MP3, and digital video disk media.

10. A machine for vending data in a system for distributing and vending data, comprising:
a data input/output subsystem;
a user input subsystem for selecting data; and
a transaction subsystem,
wherein the machine vends selected data in accordance with inputs to the machine via the user input subsystem and the transaction subsystem.

11. The machine of claim 10, further comprising a display subsystem for previewing and selecting data.

12. The machine of claim 11, further comprising a sound subsystem for previewing and selecting data.

13. The machine of claim 10, further comprising:
a plurality of blank media;
a recording subsystem;
a library; and
an inventory subsystem,
wherein the recording subsystem is adapted to detect the number of copies of data in the inventory subsystem and, if the number of copies is less than a predetermined amount, obtain data from the library and record a copy of the data onto the blank media.

14. The machine of claim 10, further comprising a security subsystem.

15. The machine of claim 14, further comprising a video subsystem.

16. The machine of claim 14, further comprising a global satellite positioning system receiver.

17. The machine of claim 10 wherein the data comprises at least one of audio, video, an electronic game and a computer program stored on at least one of a magnetic disk, optical disk, compact disk, electronic memory device, cassette, magnetic tape, MP3, and digital video disk media.

18. A method for vending data, comprising the steps of:
initiating a transaction;
displaying a menu;
selecting data from the menu;
making payment for the selected data; and
vending a medium containing a copy of the selected data.

19. The method of claim 18, further comprising the step of previewing the data before selecting the data.

20. The method of claim 18, further comprising the steps of:
reviewing a customer and a selection made by the customer;
determining whether the selection is appropriate for the customer, in accordance with predetermined criteria;
allowing the transaction to be completed if the selection is appropriate; and
deleting the selection if the selection is not appropriate.

21. The method of claim 20 wherein the predetermined criteria is the age of the customer and an industry rating of the data.

22. The method of claim 20 wherein the predetermined criteria is authorization data.

23. The method of claim 18 wherein the payment is by at least one of a credit card and a debit card.

24. A method for controlling the inventory of a machine for vending data, comprising the steps of:
building an initial inventory comprising copies of the data;
monitoring sales of the inventory; and
generating additional copies of the data when the inventory reaches a predetermined level.

25. The method of claim 24, further comprising the steps of monitoring the machine for a special order of data and generating a copy of data to fulfill the special order.

26. The method of claim 24, further comprising the steps of monitoring the inventory for data in low demand and informing users of the machine of incentives designed to encourage sales of the low-demand data.

27. The method of claim 24, further comprising the step of generating an algorithm to determine the predetermined level of inventory.

28. The method of claim 24 wherein the data comprises at least one of audio, video, an electronic game and a computer program stored on at least one of a magnetic disk, optical disk, compact disk, electronic memory device, cassette, magnetic tape, MP3, and digital video disk media.
